(19) United States
(12) Patent Application Publication
(10) Pub. No.: US 2015/0010289 A1
(43) Pub. Date: Jan. 8, 2015

(54) MULTIPLE RETAIL DEVICE UNIVERSAL DATA GATEWAY

(71) Applicant: Timothy P. Lindblom, Clearwater, FL (US)

(72) Inventor: Timothy P. Lindblom, Clearwater, FL (US)

(21) Appl. No.: 14/324,008

(22) Filed: Jul. 3, 2014

Related U.S. Application Data
(60) Provisional application No. 61/842,700, filed on Jul. 3, 2013.

(51) Int. Cl. G11B 27/30; G06F 17/30; G11B 27/34

(52) U.S. Cl. CPC G11B 27/30; G11B 27/34; G06F 17/3082; G06F 17/30793
USPC 386/241

(57) ABSTRACT

Auditing images including the steps of acquiring events and images, storing of images for later retrieval and viewing, distributing filmstrips, viewing stored images, viewing distributed images, recycling images on storage media based on business rules, acquiring images from a live or recorded local video source by extracting images from the live or recorded video at particular times based on events acquired from certain devices existing in a local business environment, wherein the images are then compiled into a filmstrip based on business rules along with event metadata based on business rules and then stored on a local electronic storage media(s) and optionally a remote storage media for later retrieval and viewing. The filmstrips are then automatically distributed electronically to interested parties.

### BACKGROUND OF THE INVENTION

1. Field of the Invention

This invention relates to video and image enabled business management software. More particularly, this invention relates to business reporting, event management, exception management and loss prevention software that mines data from multiple devices, pinpoints defined activity, and refines related video and images for distribution or storage with metadata to improve local or remote business functionality, including evaluation and assessment of events in business and industry.

2. Description of the Background Art

Present day video enabled business management software typically comprises storing device exceptions (e.g., data events, suspects, items taken, people involved, and vehicles) that are hyperlinked to a video repository containing the associated video. Incident queries/reports may be generated based upon the device exceptions allowing the user to access the specific video segments via the hyperlink for further review and verification of the incident (e.g., motion event, internal/external theft, multiple refunds, sweet hearting, coupon fraud, employee error, bottom-of-basket and customer oversights). Unfortunately, however, manual review of each device exception and the hyperlinked video segment, is highly time consuming. Moreover, implementation of loss prevention software typically requires custom programming that is dependent on the devices in use. Accordingly, there presently exists a need for universal video and image enabled event management software that is easily integrateable with a plethora of industry standard devices.

Therefore, it is an object of this invention to provide an improvement which overcomes the aforementioned inadequacies of the prior art and provides an improvement which is a significant contribution to the advancement of the video enabled business reporting and loss prevention software art.

Another object of this invention is to provide a more efficient and expedited manner in which to view, review, use and analyze physical and data events associated with normal operations of business and industry, including loss prevention, event monitoring or retail facility management, by pinpointing defined events and extracting, refining and distributing relevant images from a video source to designated recipients in a scheduled manner, on demand, or in real-time.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises a flexible and innovative video and image enabled business management tool featuring multiple device data mining, and a broad range of real time, event driven, local and enterprise tools that simplify event management and report and data analysis, and pinpoints and distributes targeted events for evaluation, review or use in real-time. The video and image enabled software is particularly suited for use in convenience stores, quick service and table service restaurants, specialty shops, grocery stores, big-box retail, warehousing and industrial applications, among others. The video and image enabled business management software includes exception based tools and alerts, that enable local and remote staff, and corporate executives to review or evaluate specific events in a scheduled manner, on-demand or in real time. Importantly, data is mined and available in real-time from a plethora of industry standard devices and integrated in a common database format, allowing immediate review of metadata with images or video frames.

The image auditor portion of the invention extracts video clips from the local video management system associated with defined business evets and creates filmstrips of images based upon operational, management, loss-prevention or other business information needs. The protocol of the image auditor is Requested Globally, Executed Locally, Distributed Globally, Dynamic Aggregation:
1. Business Management Hardware and Software Create Data Events in Archived in Report Form
   a. Defined Event or Rule Violation by CBS Storekeeper or CBS Remote Hub
   b. Receipt of Defined Event from Proprietary Application
2. CBS Storekeeper/Services Process Event or Proprietary Input and Generate Image Auditor Request
   a. Specific Data for Event
   b. Associated Data
   c. Video clip
   d. Single Images
   e. Filmstrip
3. CBS Storekeeper/Services Query VMS for Time and Cameras Information
4. CBS Storekeeper/Services Acquires Video From Proprietary DVR, VMS, or VMS Storage Drive
   a. Using Web Services
   b. Using VMS API/SDK
   c. Using Microsoft AVI/DirectX libraries
   d. Using COM Objects
5. CBS Storekeeper/Services Process Video by Defined Parameters
   a. Processing by defined parameters in memory
      i. Elapsed time required
      ii. Resolution Reduction
      iii. Frame Rate Reduction
      iv. Selected coordinates extracted
      v. Assembly of Stills, Filmstrip or refined video clip
      vi. Add hyperlinks and connectivity protocol per provisional patent diagrams
      vii. Add reports and links
      viii. Add Designated recipients
      ix. Add Distribution Protocol
      x. Aggregate by rule
   b. post to local secondary storage
   c. push or pull transmission to cloud, server, IP address
   d. distribute to tablet, server, web app, laptop or smart phone
6. Construction and Review of Filmstrip, video clip or images
   a. Display Events and images
   b. Flag events or images
   c. Push refined/full filmstrip and/or report to designated recipients.

More particularly, a main overview of the image auditing protocol is as follows:

1. Acquire Events and Images
a. Acquire event data
b. b. Acquire relevant video clip
c. extract images
d. Tag Images w/metadatareate Filmstrips

2. Storage of Images for later retrieval/viewing
a. Saved to storage (can be multiple locations based on business rules)
   i. Add metadata to catalog
   ii. Save metadata with images
b. Perform Recycle on Images based on business rules

3. Distribute filmstrips
a. Filmstrips may be aggregated based on configuration/business rules
b. Based on business rule for event add communication protocol
c. Add addressees based on business rule and communication protocol
d. Create message document containing filmstrip(s) per communication protocol
   i. Attached hyperlinks
   ii. Attach additional metadata per communication protocol
e. Transmit message document to addressees based on communication protocol

4. View Stored Images
a. Read Image Tags and open desired filmstrip in viewer application
b. Read Image Catalog metadata and open desired filmstrip in viewer application
c. Filmstrips/Images may be Annotated, Tagged and Stored
   i. Perform Recycle on Storage
d. Filmstrip/Images may be Annotated, Tagged and Distributed

5. View Distributed Images
a. Read Image Tags and open desired filmstrip in viewer application
b. Read Image Catalog metadata and open desired filmstrip in viewer application
c. Filmstrips/Images may be Annotated, Tagged and Stored
   i. Perform Recycle on Storage
d. Filmstrip/Images may be Annotated, Tagged, and Distributed

6. Recycle Images on Storage media based on business rules
a. This recycling application will delete specific images based on business rules.

By way of example, the image auditing of the invention may be employed in a Retail Exception Multiple Store Audit, as follows:

1. Acquisition of Events and Images
a. Acquisition of Event Times from Proprietary Method
   i. Storekeeper application (running in Windows PC) receives POS transaction data in real time from Gilbarco Passport POS Register 1 and Register 2
      1. Data is analyzed, parsed, time coded and stored in daily Access Database
         a. The Register number (known as a device) is also stored
   ii. Auditing Service application is running on same Windows PC as Storekeeper
      1. At 1:00 am (a configured time) the service queries the previous days transaction database (this is known as post processing)
         a. The queries are based on criteria (known as exceptions) stored in an Access Database (as a collection these are known as business rules)
      2. Each result of the query (known as an event) contains a time code along with transaction information (this transaction information is known as metadata)
      3. For each event, the two preceding transaction event and the next three transaction event on the same device are added to event metadata
         a. These settings are in the AS configuration file
      4. For each event, images are extracted from a video source (this video source is a collection of recorded video files)
         a. The Audit Service (AS) application connects via TCP to another application called Liveserver (LS)
         b. The AS then sends a request to LS to retrieve images from camera 1 video files based on a set of a time codes and the device number the event was received on
         i. These returned images will make up what is known as a filmstrip for the event
         ii. These time codes are determined by configuration rules stored in the AS configuration file
         1. Starting at 30 seconds before the event and every 5 seconds until the event, images are retrieved
         2. An image with a time closest to the event time is retrieved
         3. Starting at 5 seconds after the event and every 5 seconds after the event until 60 seconds after the event, images are retrieved
         4. All time intervals are based on exception types and are configurable per exception
         iii. The Camera assignment is based on configuration rules stored in the AS configuration file
         iv. These images are returned in a JPEG format with the same dimensions as the video source
         1. If the video source have video dimensions of 640 pixels width by 480 pixels height, then the image would have dimensions of 640 pixels width by 480 pixels height
         a. These images can also be returned in other resolutions than the original video source, this would be determined by a configuration file for the AS
         c. After the AS receives the images, the event metadata is encoded into the JPEG's EXIF fields
         i. A unique ID known as a GUID is assigned for the event, this event ID is then written as metadata to each image creating a common identifier linking the images
         d. If a single camera source is being used for multiple devices then a region of interest is extracted from the returned image(s) and a new image is created from the original
         i. The region of interest is a predetermined region based on configuration information for the AS that has the region's top, left, width, height coordinates in relation to the original image
         ii. This new extracted image then replaces the original image and is also encoded with metadata
         iii. These images are stored in memory until ready for storage and distribution
         e. This process is repeated until all events have been processed

2. Storage of images/filmstrips to a storage media
a. The AS aggregates the images into a compressed zip file (a standard computer file format)
   i. The zip file is named with a GUID with the date of the events appended to it
b. The AS uploads the file to a Windows Azure account (one per client)
   i. This file will be retrieved later by another application (ASSA)
c. The Audit Service Storage Aggregator downloads this zip file at a set time (2:00 am, based on a configuration file)
d. The ASSA extracts the images and organized them in computer folders on a hard-drive(s) based on client, site location, exception, and date

3. Distribute filmstrips
a. This solution does not auto distribute filmstrips, this is done manually by a user (of the Viewer Application in Step 4)

4. Viewed Stored Images
a. The Image Auditor (IA) application on starting reads thru a file directory and loads all site names it finds
   i. These can be limited/modified by the IA configuration file
   ii. These site names get loaded into a treeview control on the upper left side of the application
b. The user then selects a site from the list of site names
   i. The IA will then parse thru the site name's file directory to determines the dates it has images available
   ii. It will create a count of events that have not been reviewed (audited)
      1. Events already reviewed are listed in a corresponding xml file that exists in the same directory as the images
      2. These counts will be displayed in a treeview control in the lower left
         a. This is organized by exceptions
         b. Then organized by dates
         i. A count is listed next to date for total exceptions not reviewed
      3. The user selects a date and a corresponding image is displayed for each event (whether reviewed or not) in either a filmstrip view control or a coverflow view
         a. The image displayed for the event is the image with the time code closest to the event
         i. This is configurable in the IA
         b. The metadata for the event is displayed in a textbox below the event image, with the transaction detail that matched the exception criteria highlighted in red
         c. A button control appears above the image to allow the image to be marked as viewed (can also be done by keyboard shortcut
         d. A button control appears above the image to allow the user to view all the images corresponding to the event
      4. The user browses the events/images and based on criteria (based upon retail loss prevention techniques and skills) selects an event to audit further and clicks on the filmstrip button
         a. This displays a new window that displays all images for the event (a filmstrip of images with a time code above each image
         b. The filmstrip is centered on the image closest to the event and then images before event are displayed to the left and images after the event are displayed to the right
         c. The metadata for the event is displayed in the same manner as in events view
         d. A textbox control is available for the user to annotate the event
         e. Each image can have a section highlighted to draw attention to an area of interest
         f. An email alert can be created from this view by the user clicking on the alert button
         i. Metadata will be included in the body of the email
         ii. Annotation will be included in the body of the email
         iii. A list of email addresses related to the client are available for distribution
         iv. An alert type is available for selection which will be include in the subject title and body of message
         v. Selected image are attached to email
         1. Hyperlinks to the images being stored in an Azure cloud account is also an option
         g. The user can also select a button control that links to the video source and camera related to the event
         i. This will open up Storekeeper with a connection string that allows Storekeeper to connect to the DVR that stores the video where the images where extracted from
      5. This process is repeated for all dates, exception, and sites as per business agreement

5. Viewed Distributed Images
a. The user opens up their email client application
   i. This could also be a web site/application
b. The application displays the email message generated by the IA
c. The user may then forward this message, delete it, and/or save it for future reference

6. Recycle Images on Storage Media based on business rules
a. The ASSA application at periodic times (based on configuration files) deletes images from the computer's hard drive (the storage media) that are five days old or older (based on configuration)
b. The ASSA application at periodic times (based on configuration files) deletes images from the Azure Cloud account that are five days old or older (based on configuration)
c. The AS application at periodic times (based on configuration files) deletes images from the local DVR hard drive that are five days old or older (based on configuration).

In another example, the image auditor of the invention may be employed as a Y Lane Touch Line Auditor used to help process payments and food delivery in a drive-though fast food restaurant environment. It is critical that the order in view of the caahier and expediter match the customer/automobile, specificclly in the case of persons in automobiles ordering from multiple lanes converging into one lane to pay and retrieve their order. Because orders are queued based upon the time at the beginning of the order the automobiles may therefore be out of sequence based upon the length of the orders or other factors. Therefore cars arriving at the cashier window may not appear in the proper sequence. More specifically, if a family of 6 begins an order then 3 smaller orders are subsequently placed in the adjacent lane the first order will be listed first in the queue of the cashier. With the Image Auditor the images of multiple customers are displayed simultaneously with the order detail and the cashier can simply confirm the correct customer/order visually. By having the image and order number displayed together, the cashier can quickly see which order corresponds to the automobile that is currently at their window allowing for faster recall and less confusion. The exemplary protocol is as follows:

1. Acquisition of Events and Images
a. Acquisition of Event Times from Proprietary Method
   i. Storekeeper application (running in Windows PC) receives POS transaction data in real time from NCR Aloha POS Register 1 and Register 2
      1. Device Data is analyzed, parsed, time coded and stored in daily Access Database
         a. The Register number (known as a device) is also stored
      2. Device Data is compared against certain saved criteria
         a. This criteria is stored in a configuration file
         b. The criteria includes POS register number
         c. The criteria includes lane information
         d. The criteria includes a live camera source that matches the lane number
         e. The data analytics confirm that the transaction is a new POS order
      3. If criteria matches, a live image is saved from a live video source that matches configuration data for the lane number
         a. Storekeeper receives a constant live video feed via a COM integration with Geovision
         b. A command is called to save the current acquired image from Geovision for the configured channel
         c. Image is saved in a jpeg format
         i. The directory where the image is saved is a temporary directory
         ii. Image names are unique names based on system time and the channel number of the camera
         d. This image is saved with a resolution of 320 pixels×240 pixels
         e. Metadata is written to the images EXIF tags which includes the order number of the transaction
         f. The image is then moved from the temporary directory to a new directory such as “c:\y drive images”
      4. The lane number may change for the current order and the old image is deleted and a new image is created following the steps above
      5. Device data may match other criteria which will update/add metadata to the image's EXIF tag
         a. Other criteria could be of type void
         i. This writes void to the metadata EXIF tag on the image that corresponds to the transaction order number
         b. Other criteria could be of type multi-order
         i. This writes multi to the metadata EXIF tag on the image that corresponds to the transaction order number
         c. Other criteria could be of type Total
         i. This writes Total to the metadata EXIF tag on the image that corresponds to the transaction order number

2. Storage and Recycle
a. Storekeeper saves images (per above)
b. Images may be deleted via a batch file on Windows startup
c. Images may be deleted by the Touch Line Auditor (known as TLA) after x number of images exist in its image directory or after y seconds.
   i. This image directory is the directory where Storekeeper moves images to
   ii. The oldest images will be deleted first
   iii. A certain number of y images will not be deleted
      1. This number is configured in TLA

3. A separate viewing application (TLA) runs on a computer
a. This application normally runs on the same computer as Storekeeper but this is not required
b. TLA on startup hooks into the file system and watches a particular directory for the addition of new images
   i. This directory is the same directory as configured in Storekeeper where images are moved to (normally c:\y drive images)
c. When a new image is received the TLA displays this image within the application
   i. This image will display after older images
   ii. The application can be run as multiple instances that run independently except for a shared configuration file
   iii. When the application is running in multiple instances, each instance will run on a single monitor on an extended desktop
d. If the image metadata is updated with the word ‘multi’ an image of a bag will be overlayed on top of the main image in a semi-opaque fashion so the original image is still viewable
e. If the image metadata is updated with the word ‘void’ an image of a circle with a line thru it will be overlayed on top of the main image in a semi-opaque fashion so the original image is still viewable
   i. There is a configurable option to remove the image from being displayed in the application
f. If the image metadata is updated with the word ‘total’ a button control above the image will have its text changed to the word ‘Paid’
   i. The text that appears is configurable
   ii. There is a configurable option to remove the image from being displayed in the application
   iii. If the order number that corresponds to the image is paid (this is known by the application because of the image metadata being updated) and there exists an image with an earlier order number that has not been paid then the TLA may perform several actions
      1. The image may be placed earlier in the sequence then the unpaid order
      2. The label control that contains the order number associated with the image may also change its text color (flash) for x seconds
g. A user of the system may also remove an image from the application display by pressing a button control above the image
   i. This button control is the same as the above for paid (3.f)
h. A user may also re-order the images by pressing a button control
   i. The image may be moved so it displays before or after another image
i. A User may also recall an image that has been removed from the display by pressing a button control called ‘recall’.

In still another example, the image auditor of the invention may be employed as a remote tool used in an audit solution:

1. Acquisition of Events and Images
a. Acquisition of Event Times from Proprietary Method
   i. Storekeeper application (running in Windows PC at a site location) receives POS transaction data in real time from Gilbarco Passport POS Register 1 and Register
      1. Data is analyzed, parsed, time coded and stored in daily Access Database
         a. The Register number (known as a device) is also stored
      2. This process is repeated at other site locations
         a. A user might have ten stores they want to monitor and distribute exception information from. The Storekeeper app would be running at each location acquiring device data
   ii. Remote Tools—Audit (RTA) is running on a remote centralized server
      1. This server is normally installed at a corporate office
      2. This server may also be a managed server on the internet
      3. At 1:00 am (a configured time), RTA starts connecting to a list of predefined sites and sends a list of queries to an application called LiveServer which runs on the same computer normally that Storekeeper is running on
         a. If there are ten sites being monitored then RTA will connect and transmit a set of queries to Liveserver at each location
         b. The queries are SQL queries (known as exceptions) that Liveserver will execute
         i. Each exception is customizable by site location
         ii. There is no limit on the number of queries that can be transmitted
      4. At each site, Liveserver will respond with a list of events results that correspond to the query(s).
         a. Each result of the query (known as an event) contains a time code along with transaction information (this transaction information is known as metadata)
      5. RTA then sends these results to the Media Archiver application (known as MA)
b. Acquisition of images and metadata
   i. MA then connects to Liveserver at each site location and sends image requests for each exception
      1. These are the same time rules as Image Auditing—Retail Exception Multiple Store Audit
      2. Liveserver retrieves the images from the video sources
         a. These are the same retrieval methods as Image Auditing—Retail Exception Multiple Store Audit
      3. Mediarchiver receives the images and performs other processing
         a. These are the same image processing rules as Image

Auditing—Retail Exception Multiple Store Audit

2. Storage and recycling
a. Mediarchiver saves these images as jpeg in folders on a computer hard drive
   i. These images are organized into filmstrips like the Image Auditing Application

3. Distribution
a. After image retrieval has been completed by MA, RTA then checks its configuration to see if there is a scheduled distribution
b. For each distribution a set of email(s) are created
   i. Configuration rules are checked to see if site image/filmstrips are to be aggregated
   ii. An email message is created in memory
   iii. Addresses are added per configuration
   iv. Metadata will be included in the body of the email that corresponds to retrieved images
   v. Retrieved images are attached or embedded into to the email per configuration
      1. Hyperlinks to the images being stored in an Azure cloud account may be placed in the body of the email
   vi. An email title message with metadata pertaining to the site(s)
c. After creation of email message in memory, each message is distributed to addressees using standard emailing communication technique
d. This process is repeated until all messages are created and distributed according to the distribution list

4. Viewing Stored Images
a. See Image Audit Step 4 for details

5. Viewing distributed images
a. The user opens up their email client application
   i. This could also be a web site/application
b. The application displays the email message generated by the IA
c. The user may then forward this message, delete it, and/or save it for future reference

6. Recycle Images on Storage Media based on business rules
a. The MA application at periodic times (based on configuration files) deletes images from the computer's hard drive (the storage media) that are five days old or older (based on configuration)
b. The MA application at periodic times (based on configuration files) deletes images from the Azure Cloud account that are five days old or older (based on configuration).

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIGS. 1A-1D are block diagrams showing a representative list of some industry standard devices, their device connectivity, data set formats, and input/data conversion summary;

FIGS. 2A-2C are block diagrams showing a representative list of device connectivity and hardware communication protocols used by industry standard devices;

FIGS. 3A-3C present a block diagram showing the database details;

FIG. 4 is a flow chart showing the device data relationship;

FIG. 5 is a block diagram showing a summary of the data/video integration and distribution protocol summary;

FIG. 6 is a flow chart showing in greater detail the data/video integration and distribution protocol;

FIGS. 7A through 7J present a flow chart showing in detail the image auditor of the invention.

Example 1 is a flow diagram showing a typical money order transaction;

Example 2 is a flow diagram showing a typical cooler temperature alert; and

Appendix A-II illustrate typical Category/Data Types for a variety of devices.

Similar reference characters refer to similar parts throughout the several views of the drawings.

### DETAILED DESCRIPTION OF THE PREFERRED EMBODIMENT

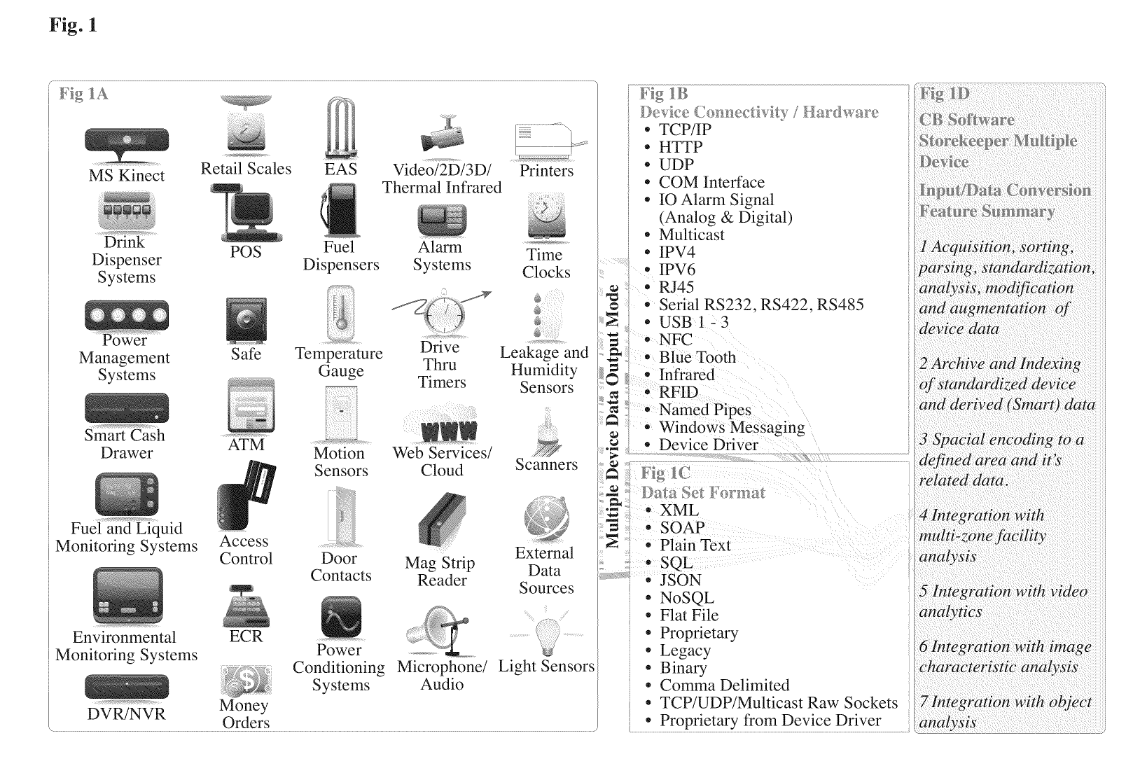

Referring to FIG. 1A, present invention is operable with a plethora of devices typically employed in establishments such as, without limitation, convenience stores, quick service restaurants, table service, specialty shops, grocery stores, big-box retail, warehousing and industrial applications, among others. For example, typical devices in a convenience store may include point-of-sale devices, electronic cash registers, fuel dispensers, drink dispensers, retail scales, smart cash drawers whereas typical devices in a warehouse may include power conditioning systems, door contacts, motion sensors and alarm systems. It should be appreciated that, without departing from the spirit and scope of this invention, the invention is adaptable to many other devices and the listing shown in FIG. 1A is merely exemplary of some of the most commonly found devices.

In accordance with the present invention, the devices communicate over a suitable communication connection. FIG. 1B lists exemplary communication hardware and software communication protocols. It should be appreciated that, without departing from the spirit and scope of this invention, the invention is adaptable to many other hardware and software communication protocols and the listing shown in FIG. 1B is merely exemplary of some of the most commonly found types of hardware and software communication protocols.

FIG. 1C lists exemplary data set formats that may be used in connection with the present invention. It should be appreciated that, without departing from the spirit and scope of this invention, the invention is adaptable to many other data set formats and the listing shown in FIG. 1C is merely exemplary of some of the most commonly found types of data formats.

As listed in FIG. 1D, the present invention achieves many features such as the acquisition, sorting, parsing, standardization, analysis, modification and augmentation of device data, archiving and indexing of standardized device and derived data; special encoding to a defined area and its related data; and integration with multi-zone facility analysis, video analytics, image characteristic analysis and object analysis.

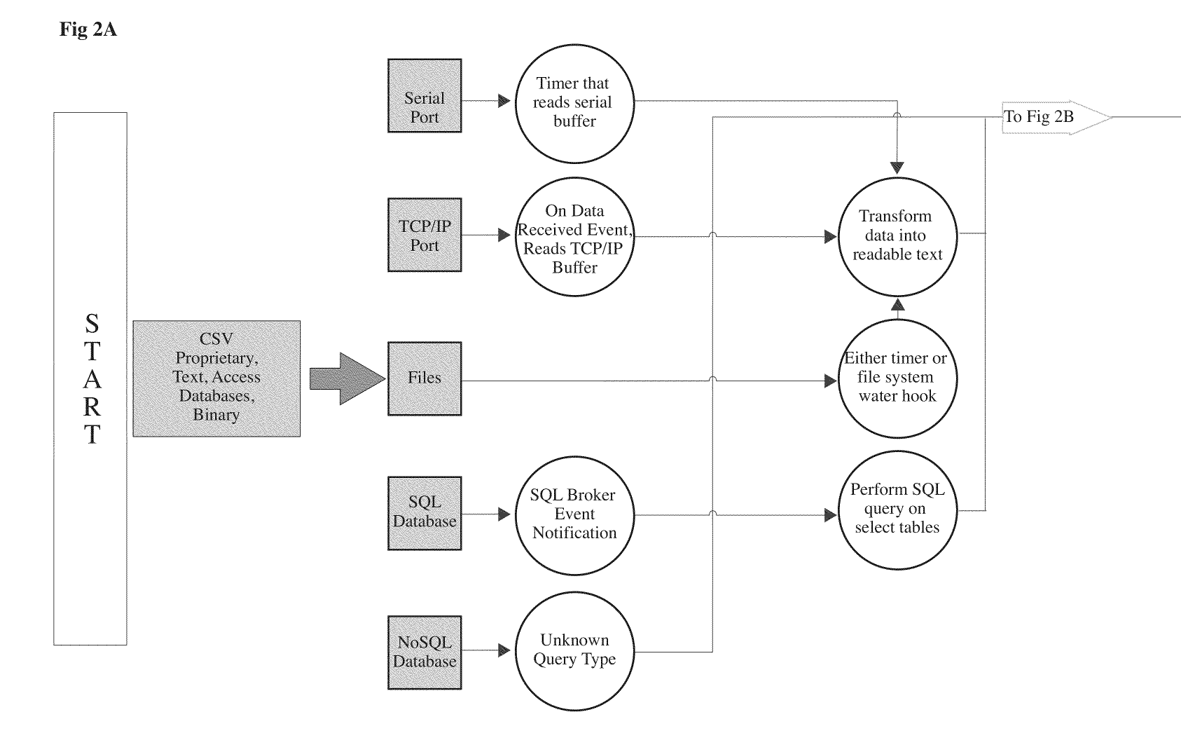

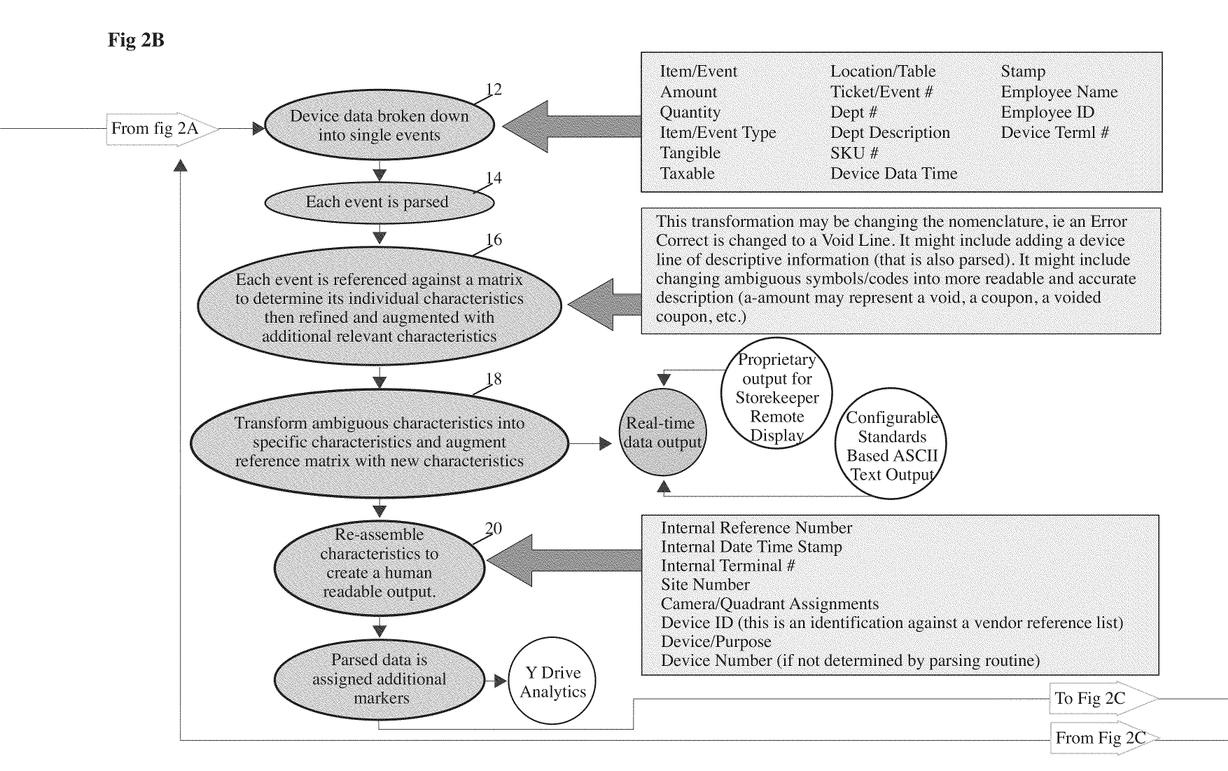

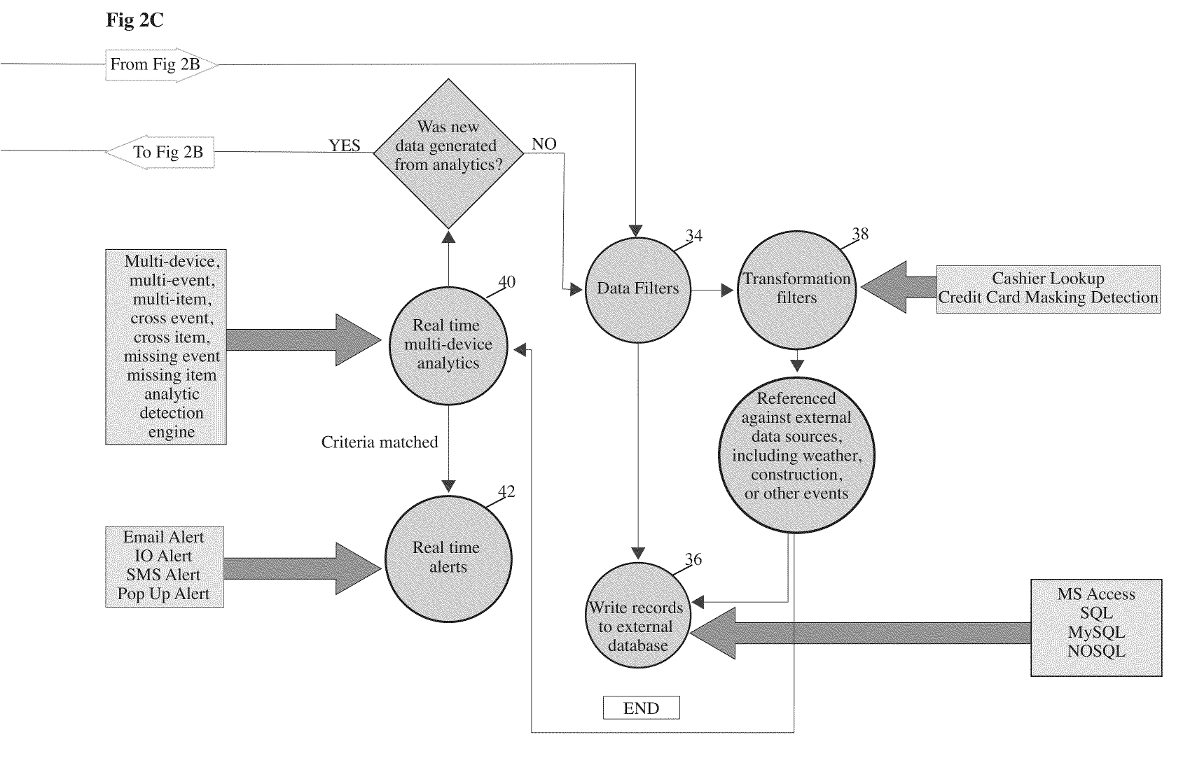

The details of the multiple device input/data conversion are shown in the flow chart of FIGS. 2A through 2C. The device inputs/data conversions are generally identified by reference numeral 10. The device data is the broken down into single events 12. Each of the events 12 is then parsed 14 against a matrix 16 to determine individual characteristics of the event 12. The ambiguous characteristics are transformed 18 into specific characteristics. The characteristics are re-assembled 20 to create a human readable output 22 for display 24 or in the form of configurable standards based ASCII text output 26. The parsed data may be assigned 28 additional markers such as listed in block 30.

Data and events are typically filtered and archived for future reference, for matrix development or archive modification. In some other cases, data is processed using the invention for specific functionality related to ongoing operations but not necessarily required in archive form for ongoing operational efficiency. For example, the Y-Drive Through application used in the Quick Service Restaurant environment requires images to be associated with specific orders to insure that the proper order is executed, rung correctly, expedited and delivered to the appropriate customer. In this case the order detail is associated with an image of the vehicle and driver in a multiple drive through environment and displayed for the cashier, cooks, expediters and delivery staff on multiple monitors throughout the facility. The image of the customer and order is placed in sequence and displayed at several stages of the transaction. The sequence of customers may be modified if the vehicles and customers do not present themselves in the expected order. After acquiring, processing and utilizing the data and images in the course of the transaction, the data and images may be of no further value to the user and may therefore be discarded.

The data is filtered 34 and stored in an external database 36. The data may also flow through transformation filters 38 before performing real time analytics via an analytic detection engine 40 across multiple devices, multiple events, multiple items, cross events and items, missing event or item. If certain criteria are matched, real time alerts 42 may be generated.

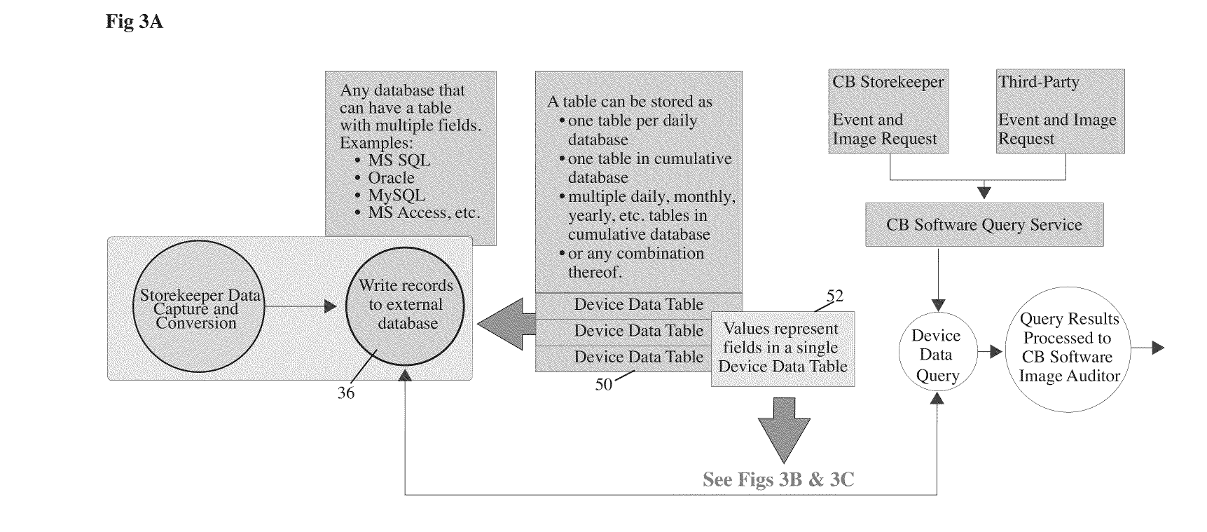

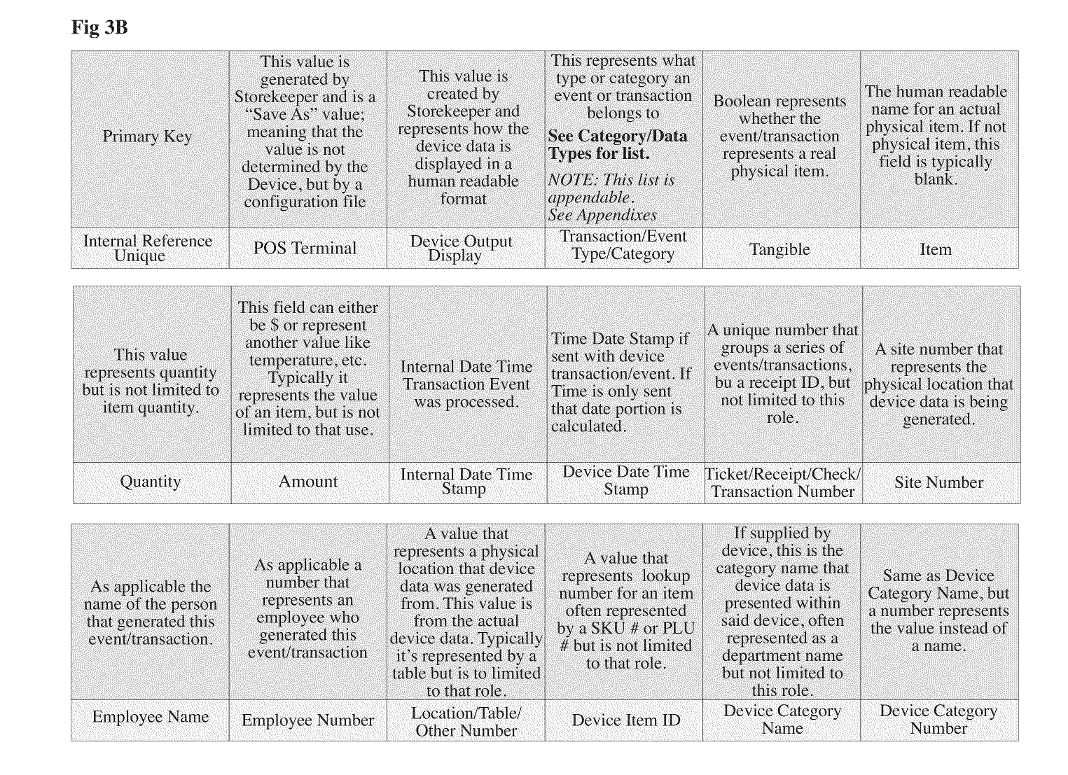

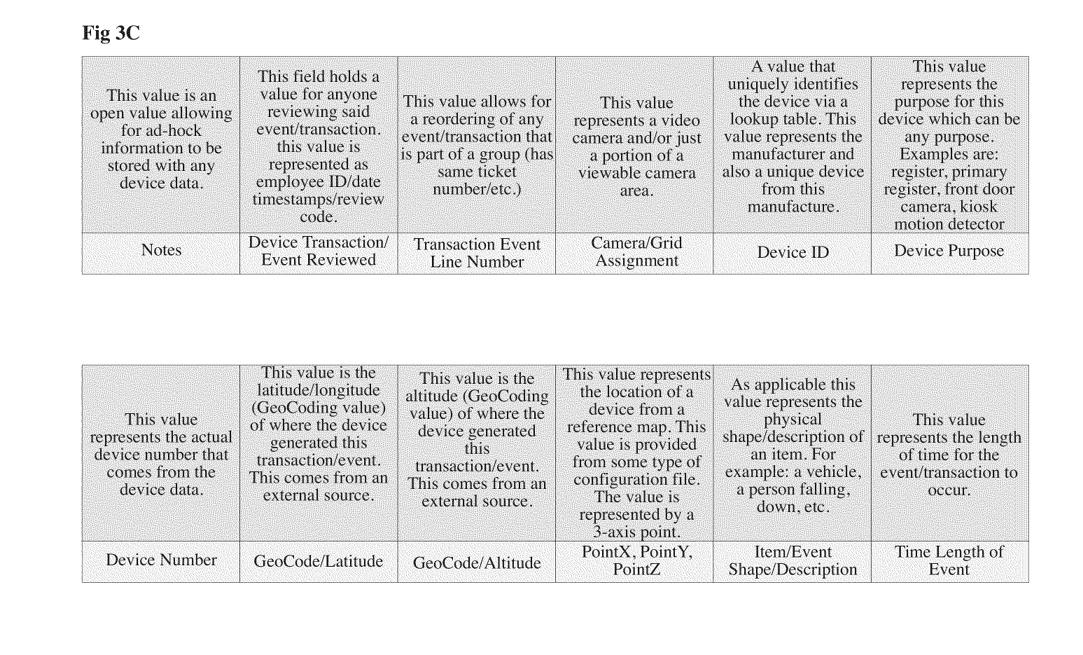

Referring now to FIGS. 3A through 3C, the database 36 employed by the present invention comprises a plurality records, each record composed of a plurality of database fields 50 categorized by field names 52. The database 36 may be of any type (e.g., XML, MS SQL, Oracle, IBM db2) stored locally or distributed in one database management system or stored locally or distributed in separate database management systems.

The fields of the database 36 are defined to store the applicable categories of data (i.e., data type) that is associated with the particular devices being employed. Appendix A-II lists exemplary categories/data types for some specific devices.

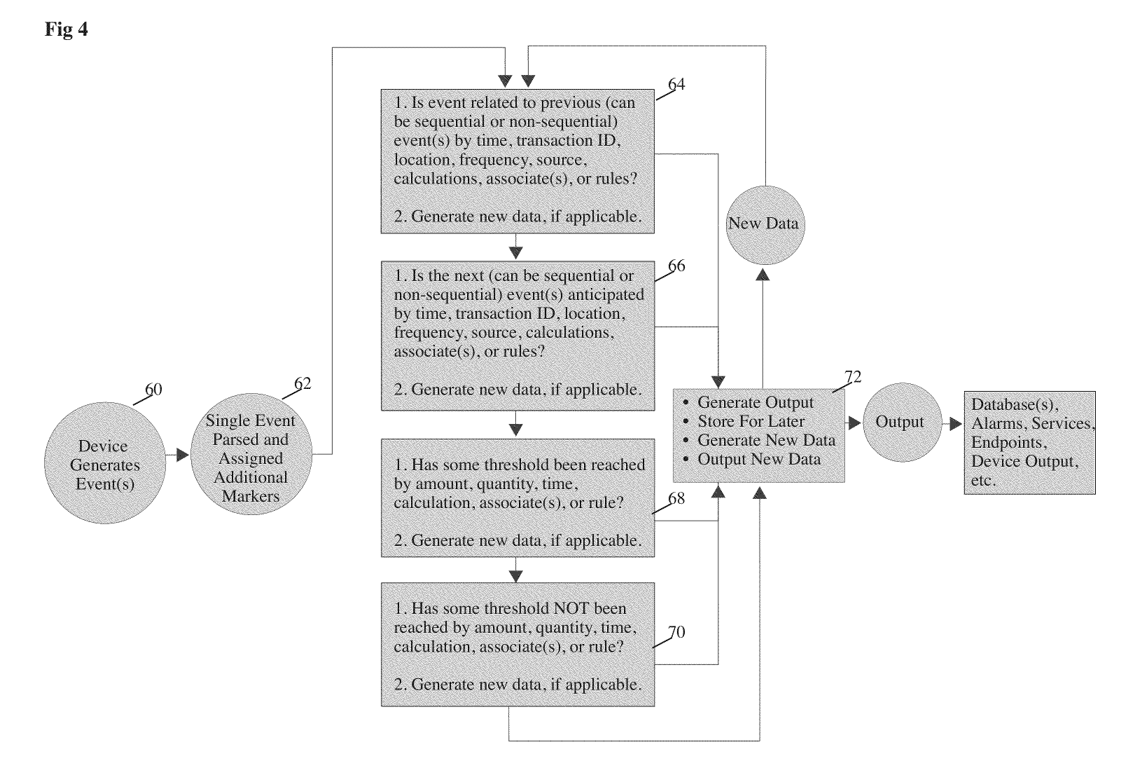

As shown in FIG. 4, when a device produces an event 60, it is parsed and assigned additional markers 62, whereupon the event is stored 72 for later if the event is related to a previous detail us event 64, is anticipated by time, transaction, etc. 66, has exceeded a predefined threshold 68 or has not exceed a predefined threshold 70.

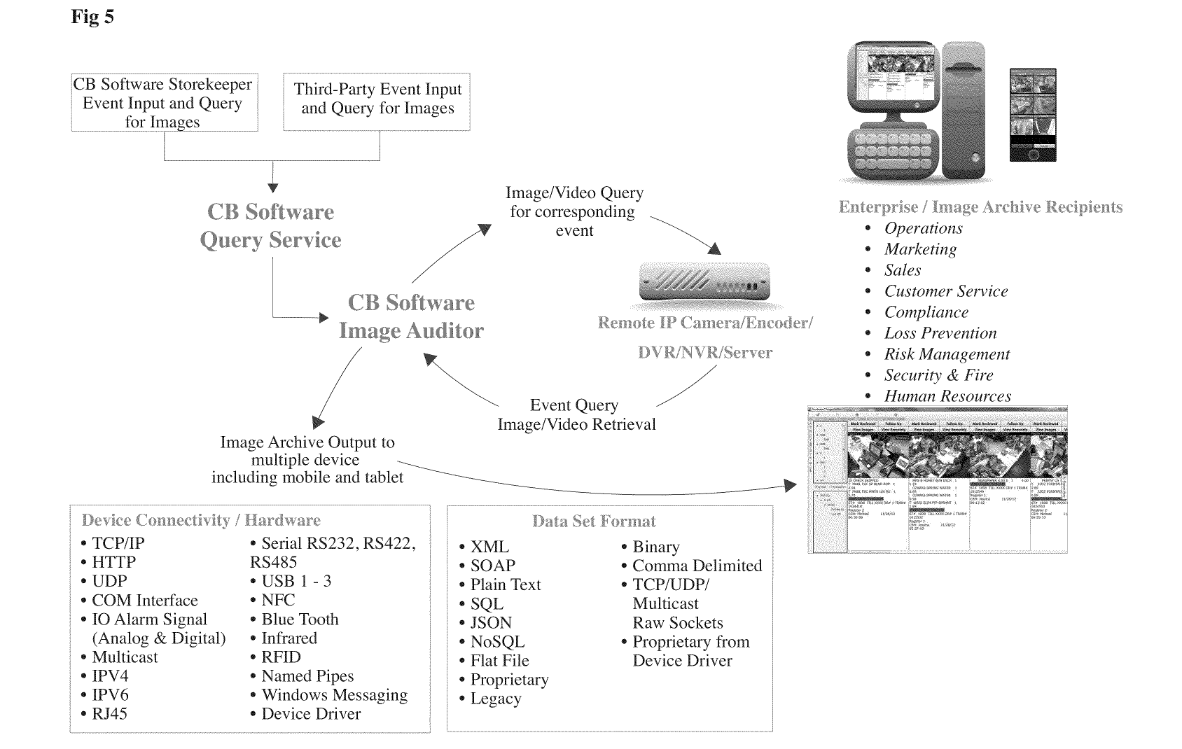

FIG. 5 is a block diagram summarizing the data/video integration and distribution protocol of the invention and the display to some of the anticipated users of the invention (e.g., operations, marketing, sales, customer service, compliance, loss prevention, risk management, security & fire and human resources).

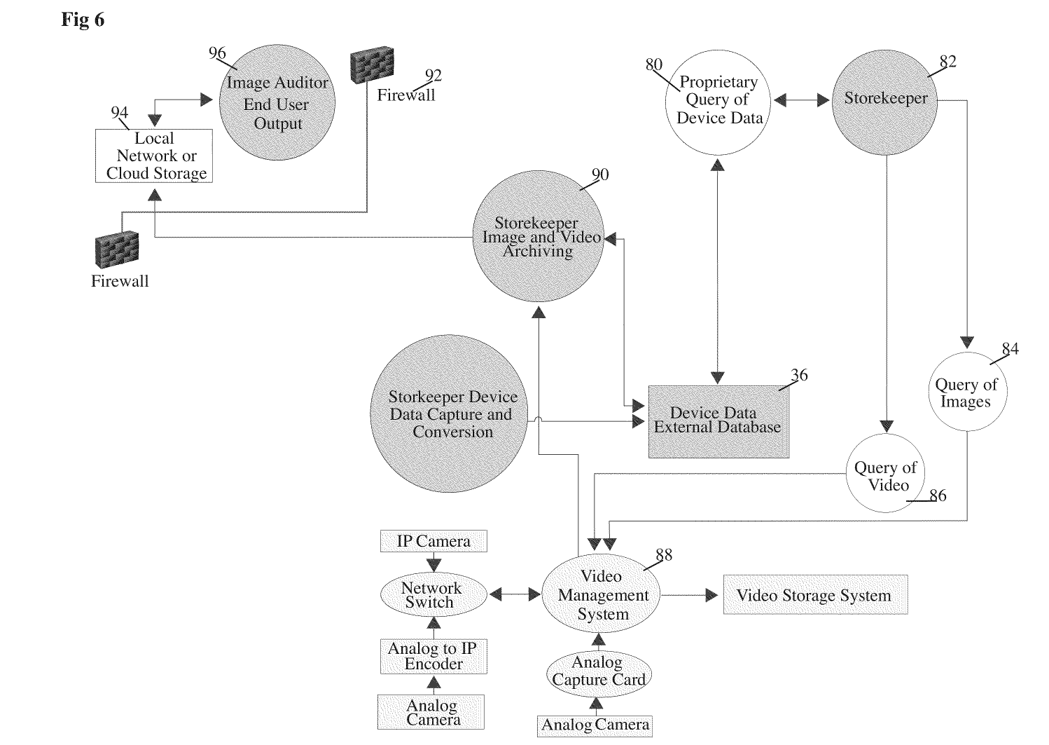

FIG. 6 is a flow chart showing further details of the data/video integration and distribution protocol. The present invention allows the user to define a proprietary query 80 which may access previously-stored data/images from the external database 36 or request new data. When the query 80 requests new data/images, the present invention via a “Storekeeper” module 82 produces appropriate image queries 84 and video queries 86, which are then sent to the user's video management system 88 to retrieve the requested images/videos. The retrieved images/video are then sent to the archival module 90 of the invention for processing in accordance with the present invention, and then stored in the database 36. The archival module 90 may output through the user's firewall 92 for cloud storage 94 and viewing 96 by the user or other properly authenticated and authorized persons.

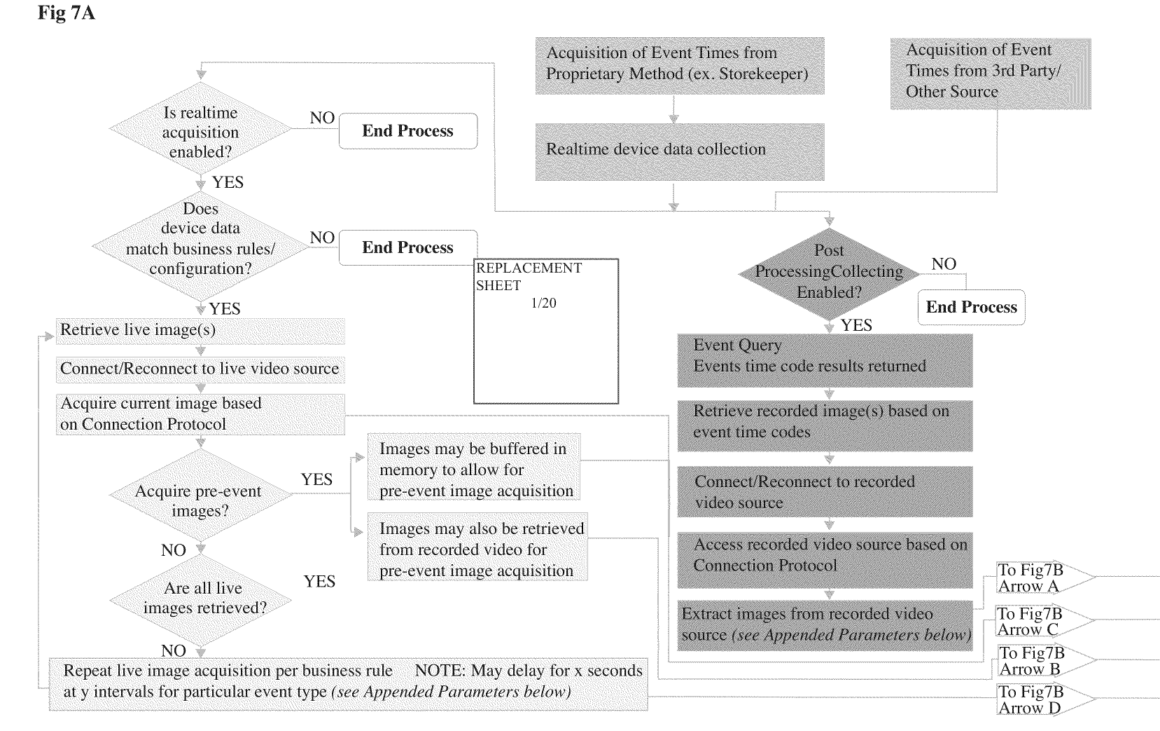

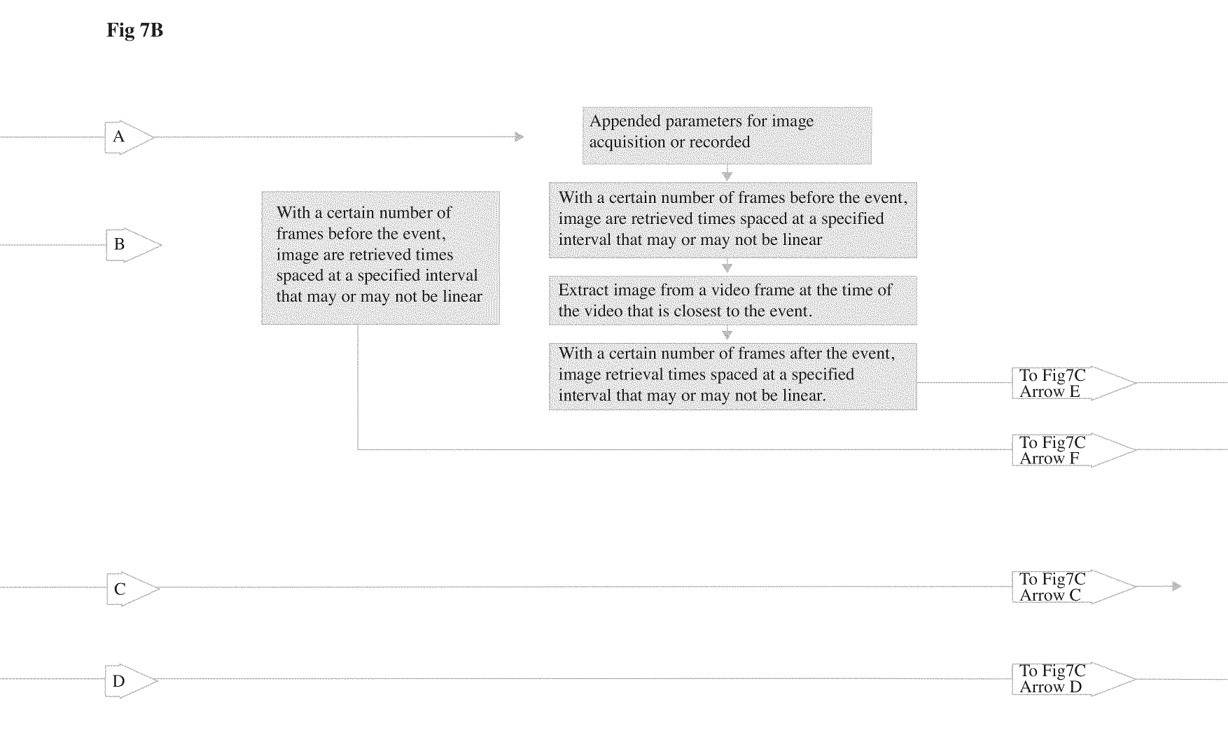

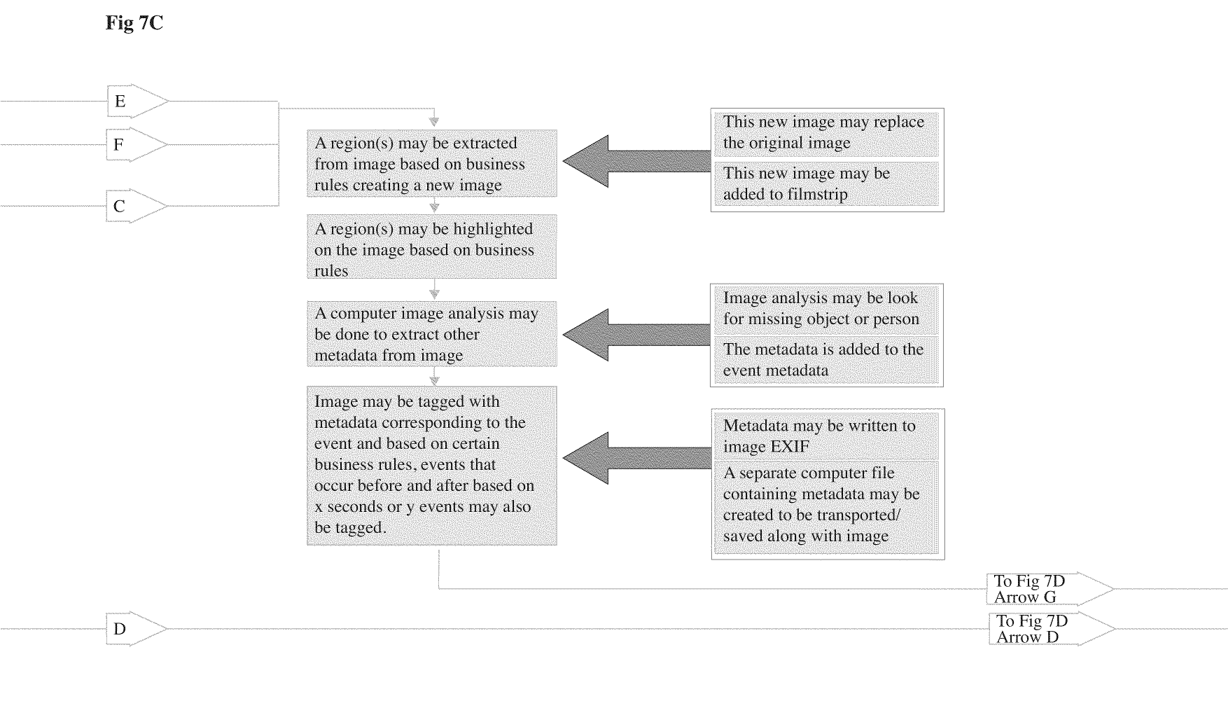

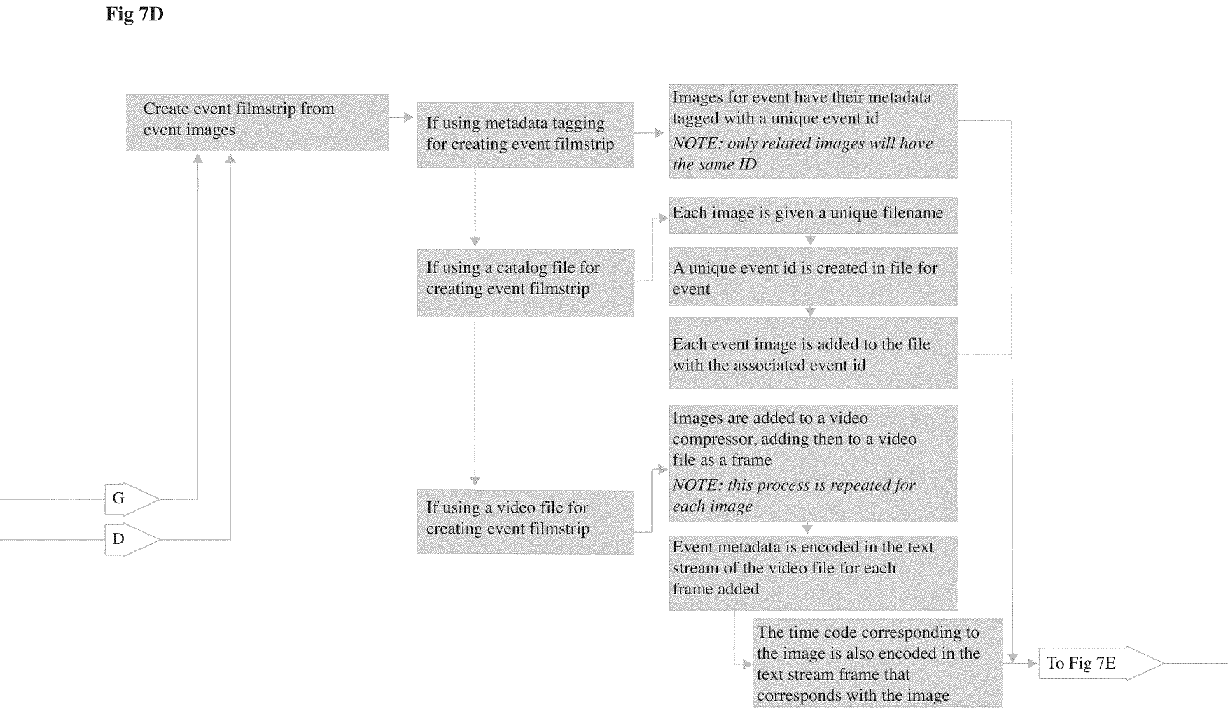

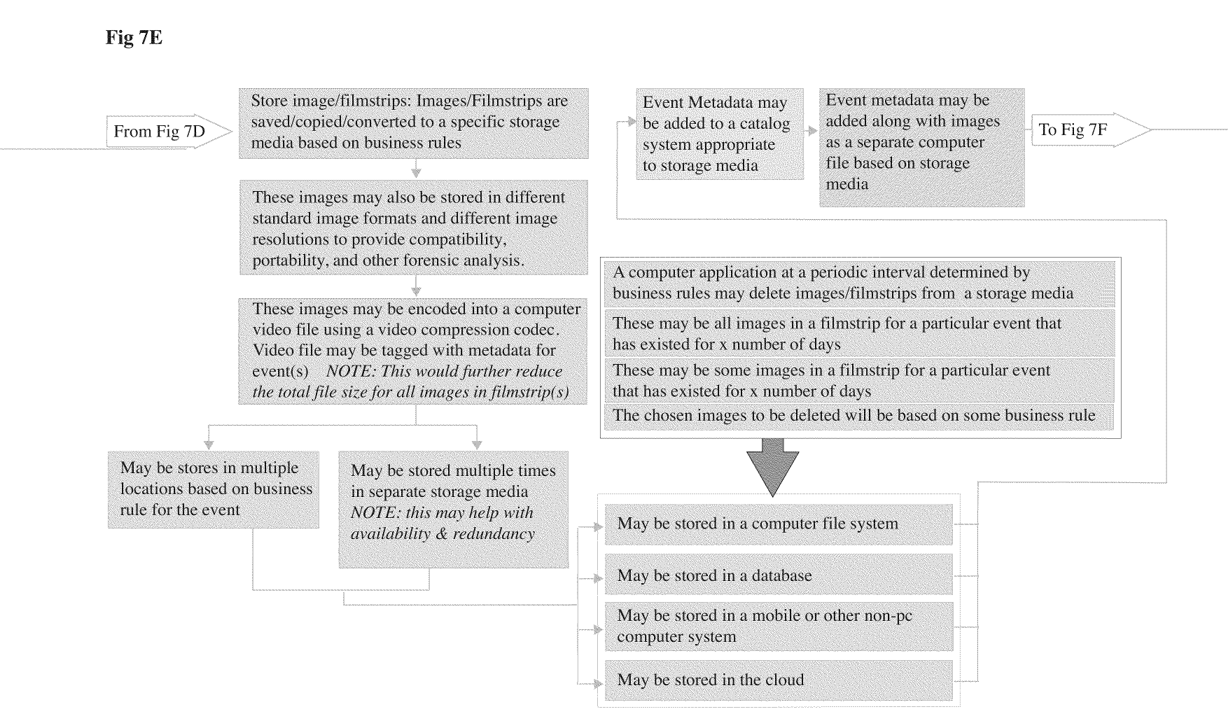

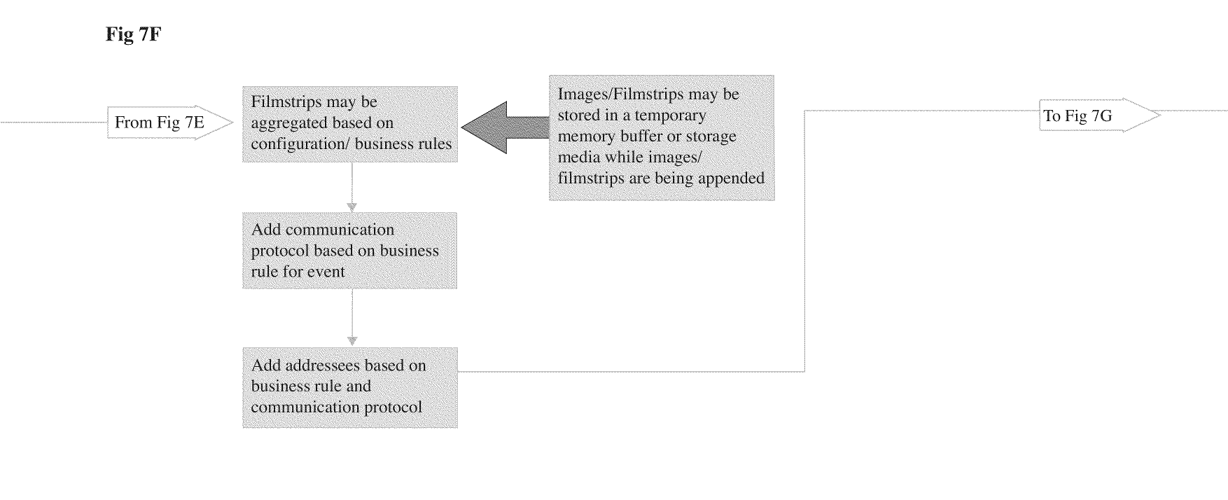

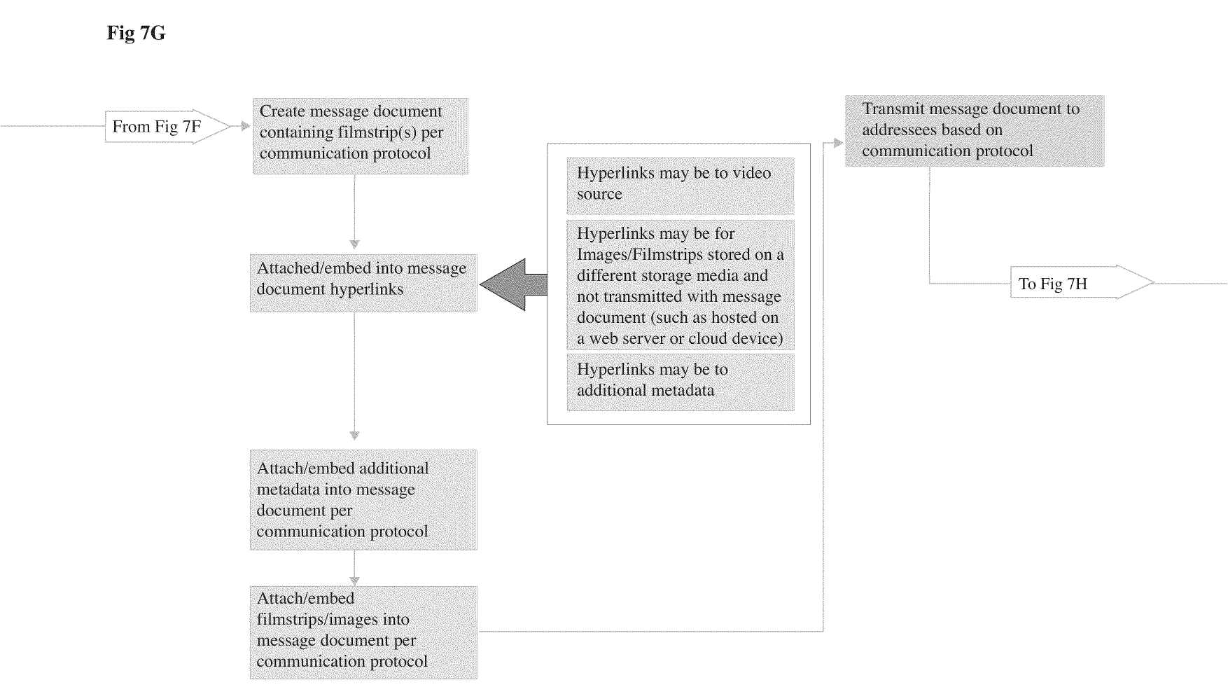

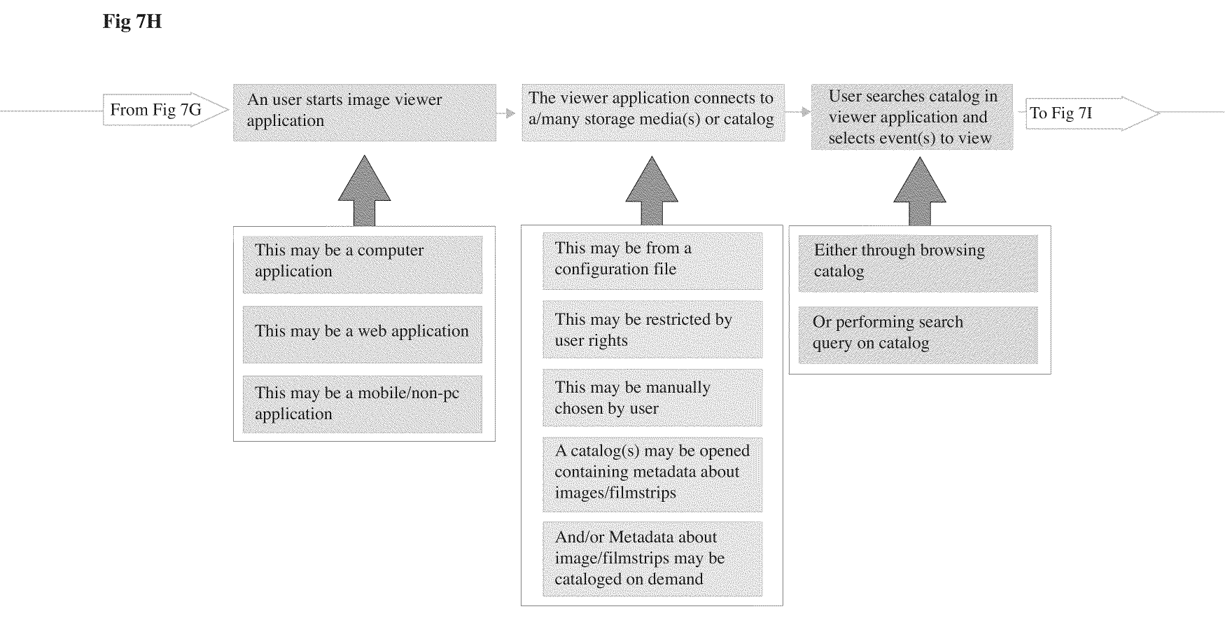

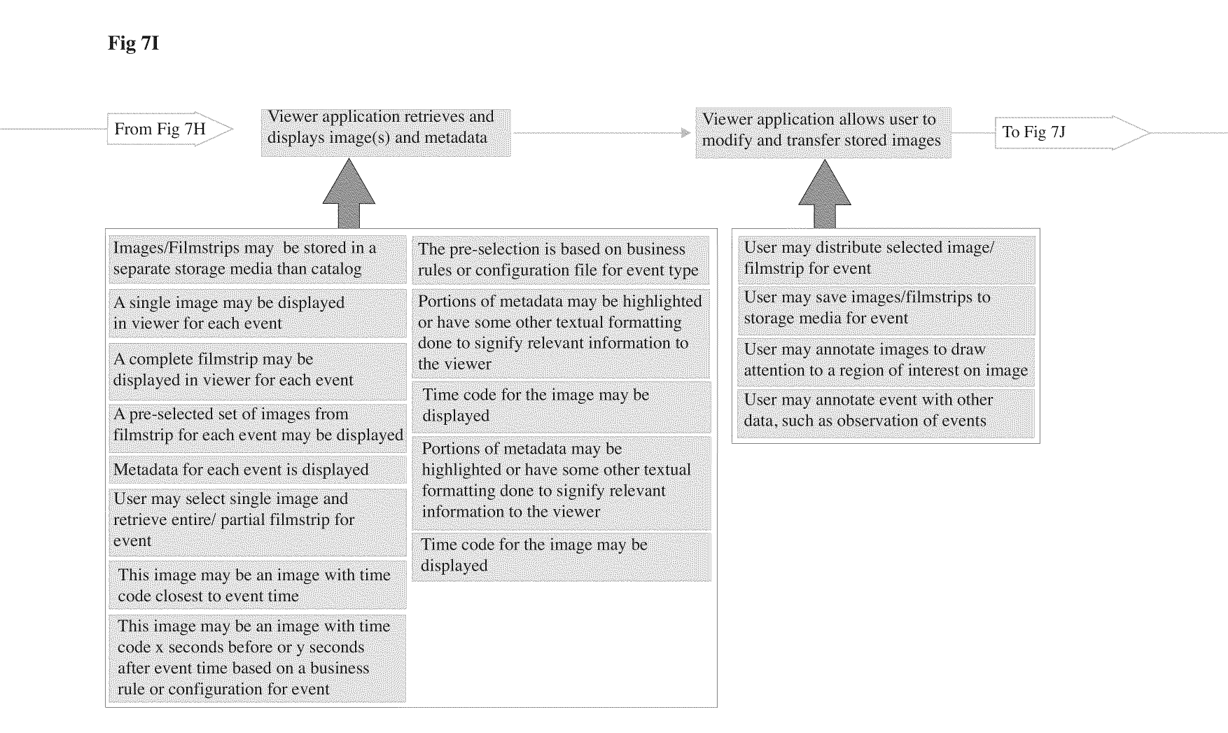

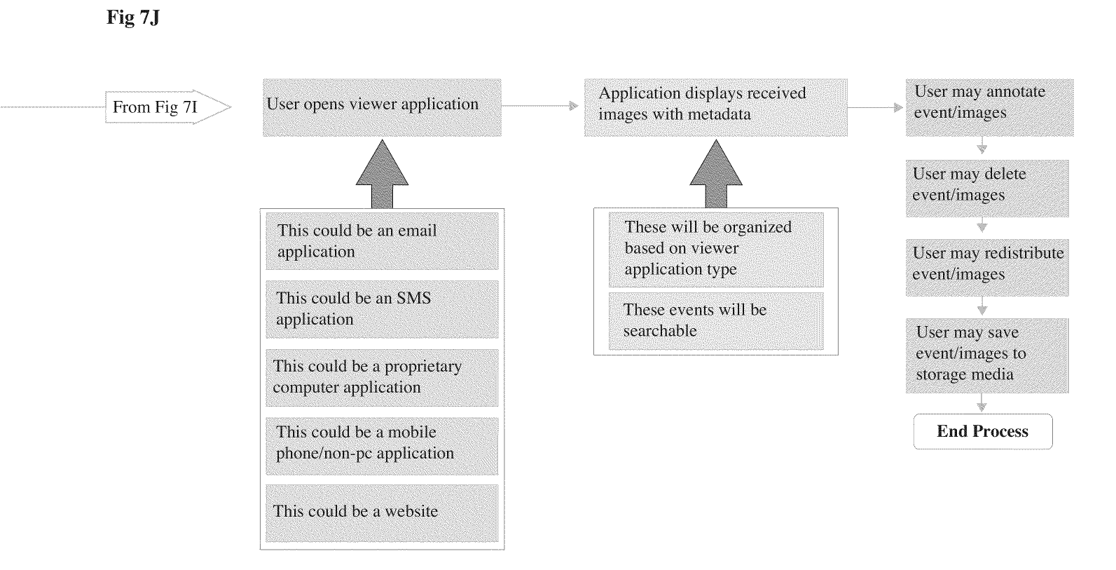

The details of the image auditor of the invention is illustrated in the flow chart of FIGS. 7A through 7J and outlined as follows:

1. Acquisition of Events and Images
a. Acquisition of Event Times from Proprietary Method (ex. Storekeeper)
   i. Real time device data collection
   ii. If Device data matches Business Rules/Configuration then
      1. If real time image acquisition then retrieve live image(s)
      2. If post processing collected data then retrieve recorded image(s)
b. Acquisition of Event Times from 3^{rd} Party/Other Source
   i. If real time image acquisition then retrieve live image(s)
   ii. If post processing 3^{rd} Party/Other source then retrieve recorded image(s)
c. If Acquiring live images
   i. Connect/Reconnect to live video source
   ii. Based on Connection Protocol acquire current image
      1. Images may be buffered in memory to allow for pre-event image acquisition
      2. Images may also be retrieved from recorded video for pre-event image acquisition
   iii. Repeat live image acquisition per business rule
      1. May delay for x seconds at y intervals for particular event type
d. If Acquiring recorded images
   i. Connect/Reconnect to recorded video source
   ii. Based on Connection Protocol, Access recorded video source
   iii. Extract images from recorded video source (see Appended Parameters below)
e. Appended Parameters for image acquisition whether video source is live or recorded
   i. With a certain number of frames before the event, image retrieval times spaced at a specified interval that may or may not be linear.
   ii. An image is extracted from a video frame at the time of the video that is closest to the event.
   iii. with a certain number of frames after the event, image retrieval times spaced at a specified interval that may or may not be linear.
   iv. A region(s) may be extracted from image based on business rules creating a new image
      1. This new image may replace the original image
      2. This new image may be added to filmstrip
   v. A region(s) may be highlighted on the image based on business rules
   vi. A computer image analysis may be done to extract other metadata from image
      1. Image analysis may be look for missing object or person
      2. The metadata is added to the event metadata
   vii. Image may be tagged with metadata corresponding to the event and based on certain business rules, events that occur before and after based on x seconds or y events may also be tagged.
      1. Metadata may be written to image EXIF
      P 2. A separate computer file containing metadata may be created to be transported/saved along with image
f. Once all images are extracted for event, a filmstrip of image(s) for the event is created
   i. This filmstrip is created by Tagging the same unique guid to the metadata on each related image
   ii. A File can also be created linking the images together based on image name and other metadata
   iii. Metadata can also be held in computer memory and transferred to a catalog or other messaging system when the images are stored or distributed

2. Storage of Images for later retrieval/viewing
a. Images/Filmstrips are saved/copied/converted to a specific storage media based on business rules
   i. These images may be stored in a computer file system
   ii. These images may be stored in a database
   iii. These images may be stored in a mobile or other non-pc computer system
   iv. These images may be stored in the cloud
   v. These images may be stores in multiple locations based on business rule for the event
   vi. These images may be stored multiple times in separate storage media
      1. This may help with availability
      2. This may help with redundancy
   vii. These images may also be stored in different standard image formats and different image resolutions to provide compatibility, portability, and other forensic analysis.
   viii. These images may be encoded into a computer video file using a video compression codec
      1. This would further reduce the total file size for all images in filmstrip(s)
      2. Video file may be tagged with metadata for event(s)
b. Event Metadata may be added to a catalog system appropriate to storage media
c. Event metadata may be added along with images as a separate computer file based on storage media

3. Distribute filmstrips
a. Filmstrips may be aggregated based on configuration/business rules
   i. Images/Filmstrips may be stored in a temporary memory buffer or storage media while images/filmstrips are being appended
b. Based on business rule for event add communication protocol
c. Add addressees based on business rule and communication protocol
d. Create message document containing filmstrip(s) per communication protocol
   i. Attached/embed into message document hyperlinks
      1. Hyperlinks may be to video source
      2. Hyperlinks may be for Images/Filmstrips stored on a different storage media and not transmitted with message document (such as hosted on a web server or cloud device
      3. Hyperlinks may be to additional metadata
   ii. Attach/embed additional metadata into message document per communication protocol
   iii. Attach/embed filmstrips/images into message document per communication protocol
e. Transmit message document to addressees based on communication protocol

4. View Stored Images
a. An user starts image viewer application
   i. This may be a computer application
   ii. This may be a web application
   iii. This may be a mobile/non-pc application
b. The viewer application connects to a/many storage media(s) or catalog
   i. This may be from a configuration file
   ii. This may be restricted by user rights
   iii. This may be manually chosen by user
   iv. A catalog(s) may be opened containing metadata about images/filmstrips
   v. And/or Metadata about image/filmstrips may be cataloged on demand
c. User searches catalog in viewer application and selects event(s) to view
   i. Either thru browsing catalog
   ii. Or performing search query on catalog
d. Viewer application retrieves and displays image(s) nearest to event(s) time
   i. Images/Filmstrips may be stored in a separate storage media than catalog
   ii. A single image may be displayed in viewer for each event
      1. This image may be an image with time code closest to event time
      2. This image may be an image with time code x seconds before or y seconds after event time based on a business rule or configuration for event
   iii. A complete filmstrip may be displayed in viewer for each event
   iv. A pre-selected set of images from filmstrip for each event may be displayed
      1. The pre-selection is based on business rules or configuration file for event type
   v. Metadata for each event is displayed
      1. Portions of metadata may be highlighted or have some other textual formatting done to signify relevant information to the viewer
      2. Time code for the image may be displayed
   vi. User may select single image and retrieve entire/partial filmstrip for event
      1. Portions of metadata may be highlighted or have some other textual formatting done to signify relevant information to the viewer
      2. Time code for the image may be displayed
   vii. User may distribute selected image/filmstrip for event
      1. See distribution protocol above
      2. User may add annotate images to draw attention to a region of interest on image
      3. User may annotate event with other data, such as observation of events
   viii. User may save images/filmstrips to storage media for event
      1. See storage protocol above
      2. User may annotate images to draw attention to a region of interest on image
      3. User may annotate event with other data, such as observation of events

5. View Distributed Images
a. User opens viewer application
   i. This could be an email application
   ii. This could be an SMS application
   iii. This could be a proprietary computer application
   iv. This could be a mobile phone/non-pc application
   v. This could be a website
b. Application displays received images with metadata
   i. These will be organized based on viewer application type
   ii. These events will be searchable
c. User may annotate event/images
d. User may delete event/images
e. User may redistribute event/images
f. User may save event/images to storage media

6. Recycle Images on Storage media based on business rules
a. A computer application at a periodic interval determined by business rules may delete images/filmstrips from a storage media
   i. These may be all images in a filmstrip for a particular event that has existed for x number of days
   ii. These may be some images in a filmstrip for a particular event that has existed for x number of days
   iii. The chosen images to be deleted will be based on some business rule

The present invention described above provides a marked improvement over present-day industry standard strategies utilizing integration of POS data and VMS platforms that feature the synchronized review of data (POS) events with archived video by means of a hyperlink from a global reporting tool or LP dashboard, which facilitates the review and analysis of the event by streaming the relevant video across a network from the retail location or the cloud. More particularly, the present invention eliminates the vast majority of bandwidth and time resources required to execute this task by extracting, parsing and refining relevant images from the VMS archive, then distributing filmstrips or single images to designated or multi-level recipients. This tactical process in effect refines the events and images to the essential information required to facilitate the investigation, rather than streaming bulk video clips. It also provides a hyperlink to the full video archive if necessary.

For example, referring to Fig. “Example 1,” in the case of a return fraud investigation, the present invention would acquire and queue a single image of the transaction from the VMS to confirm the presence of the product and customer, then compile a secondary filmstrip of the entire event (perhaps one image every 5 seconds before and after). A five minute filmstrip review of the event would consist of 60 images, pre-loaded on a desktop server or the cloud. Comparatively a 5 minute video clip at 30 FPS streaming remotely to an auditor would consist of roughly 4,500 images. In addition, to dramatically reduced bandwidth requirements, the time required to review the transaction using the present invention is approximately 10 seconds versus streaming a 5 minute video clip. More specifically, as shown in Money Order Transaction 1, when a transaction is rung at a POS terminal 100, if a money order 102 is generated and cash is deposited 104 in the safe, the sequence is approved 106, and the event is stored 108. But, as shown in Money Order Transaction 2, when a transaction is rung at a POS terminal 100, if a money order 102 is generated but cash is not deposited 104 in the safe, the sequence is not approved 106, and a query 110 is generated, which then determines 112 if the safe deposit 104 was made before the POS transaction 100. If so, the modified transaction is stored 114 in the database 36 and a report is generated 116. If not, a theft alert 118 is generated.

By way of another specific example, referring to Fig. “Example 2,” in the case of a cooler temperature monitor, where the temperature gauge registers a spike 120, the present invention will acquire and dispatch an image of the cooler door to the manager on duty facilitating immediate verification that the door is closed 122. If the door is closed and power consumption is increased as may be detected via an interface with door contacts and power consumption monitoring devices 124, the present invention determines 126 from a query of past door images if the door was left open 128. If so, a report 130 is generated and the event is stored 132 in the database 36. If not, a service order to a vendor is dispatched 134 in real time and the event is stored 132 in the database 36.

The present invention may also be used to archive credit card transactions (to facilitate review after the VMS archive expires), evaluate operations, facilitate compliance reviews, or conduct operational audits where it is impractical to stream video.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A method for auditing images, comprising the steps of:
acquiring events and images;
storing of images for later retrieval and viewing;
distributing filmstrips;
viewing stored images;
viewing distributed images; and
recycling images on storage media based on business rules.

2. The method as set forth in claim 1, wherein the step of Acquiring Events and Images comprises the steps of Taging Images with metadata and Creating Filmstrips.

3. The method as set forth in claim 2, wherein the step of Acquiring Events comprises acquiring event times from a proprietary system.

4. The method as set forth in claim 2, wherein the step of Acquiring Events comprises acquiring event times from a third party source.

5. The method as set forth in claim 3, wherein the step of acquiring event times comprises real time device data collection and if device data matches business rules/configuration then
if real time image acquisition then retrieve live images or
if post processing collected data the retrieve recorded images.

6. The method as set forth in claim 5, wherein if retrieving live images, connecting or reconnecting to the live video source, acquiring current image based on Connection Protocol and repeating live image acquisition per business rule.

7. The method as set forth in claim 5, wherein if retrieving recorded images, connecting or reconnecting to the recorded video source, acquiring current image based on Connection Protocol and extracting images from the recorded video source.

8. The method as set forth in claim 6 or 7, further comprising appending parameters for image acquisition.

9. The method as set forth in claim 8, wherein the step of appending parameters for image acquisition comprises acquiring frames before the event at spaced intervals, acquiring frames at the time closest to the event, acquiring frames after the event at spaced intervals.

10. The method as set forth in claim 9, wherein the spaced intervals are non-linear.

11. The method as set forth in claim 9, wherein the spaced intervals are linear.

12. The method as set forth in claim 9, further including extracting a region from the image based upon the business rules and creating a new image.

13. The method as set forth in claim 12, wherein the new image replaces the original image.

14. The method as set forth in claim 12, wherein the new image is added to the filmstrip.

15. The method as set forth in claim 12, wherein the region is highlighted based on business rules.

16. The method as set forth in claim 12, further comprising the step of conducting a computer image analysis to extract other metadata from image whereupon the metadata is added to the event metadata.

17. The method as set forth in claim 16, wherein said computer image analysis detects a missing person or object.

18. The method as set forth in claim 9, wherein metadata is written to an image EXIF or a separate computer file associated with the image.

19. The method as set forth in claim 2, further including creating a filmstrip by tagging the same unique grid to the metadata on each related image, creating a file linking the images together based upon image name and other metadata or retaining the metadata in computer memory and transferred to a catalog or other messaging service when the images are stored or distributed.

20. The method as set forth in claim 1, wherein the step of Storing images for later retrieval and viewing comprises Saving to storage and Performing Recycle on Images based on business rules.

21. The method as set forth in claim 20, wherein the step of Saving to storage comprises saving one or more times to multiple locations based on business rules.

22. The method as set forth in claim 20, wherein the step of Saving to storage comprises adding metadata to catalog and Saving metadata with images.

23. The method as set forth in claim 21, wherein the multiple locations comprise one or more of a computer file system, a database, a mobile phone or other non-pc system, a cloud computing system.

24. The method as set forth in claim 21, wherein the images are stored in different standard image formats and different image resolutions.

25. The image as set forth in claim 21, wherein the images are encoded into a computer video file using a video compression codec.

26. The method as set forth in claim 1, wherein the step of Distributing filmstrips comprises:
aggregating Filmstrips based on configuration/business rules,
adding communication protocol based on business rule for event,
adding addressees based on business rule and communication protocol,
creating message document containing filmstrip(s) per communication protocol, and
transmitting message document to addressees based on communication protocol.

27. The method as set forth in claim 26, wherein the step of creating message document comprises attaching hyperlinks and additional metadata per communication protocol.

28. The method as set forth in claim 27, wherein the hyperlinks may be to a video source, for images or filmstrips stored on a different storage media and not transmitted with the message document or to additional metadata.

29. The method as set forth in claim 1, wherein the step of Viewing Stored Images comprises:
reading Image Tags and opened desired filmstrip in viewer application,
reading Image Catalog metadata and open desired filmstrip in viewer application,
annotating, tagging and storing Filmstrips/Images, and
annotating, tagging and distributing Filmstrip/Images.

30. The method as set forth in claim 29, wherein the step of Annotating, tagging and storing Filmstrips/Images comprises Perform Recycle on Storage.

31. The method as set forth in claim 1, wherein the step of Viewing Distributed Images comprises:
reading Image Tags and opened desired filmstrip in viewer application,
reading Image Catalog metadata and open desired filmstrip in viewer application,
annotating, tagging and storing Filmstrips/Images, and
annotating, tagging and distributing Filmstrip/Images.

32. The method as set forth in claim 31, wherein the step of Annotating, tagging and storing Filmstrips/Images comprises Perform Recycle on Storage.

33. The method as set forth in claim 1, wherein the step of recycling images on storage media based on business rules comprises deleting images based on business rules.

34. A method for auditing images, comprising the steps of
acquiring images from a live or recorded local video source by extracting images from the live or recorded video at particular times based on events acquired from certain devices existing in a local business environment;
said images are then compiled into a filmstrip based on business rules along with event metadata based on business rules and then stored on a local electronic storage media(s) and optionally a remote storage media for later retrieval and viewing;
said filmstrips are then automatically distributed electronically to interested parties;
said filmstrips, either locally stored or remotely stored are then viewed by an auditor using a computer application on another or the same computer and either saved for further review, annotated and saved for further review, deleted, or distributed via electronic means to interested parties, or annotated and distributed electronically to interested parties;
the interested party receiving the distributed filmstrips with metadata on another computer device can then audit these filmstrips using a computer application and either save them for further review, annotate and save them for further review, delete them, re-distribute them via electronic means to interested parties, or annotate and re-distribute them via electronic means to further parties;
said filmstrips periodically may be removed from storage media(s) either in complete deletion of filmstrip or partial deletion of filmstrip based on user settings.
